(19) United States
(12) Patent Application Publication
(10) Pub. No.: US 2022/0285702 A1
(43) Pub. Date: Sep. 8, 2022

(54) FUEL CELL SYSTEM

(71) Applicant: TOYOTA JIDOSHA KABUSHIKI KAISHA, Toyota-shi (JP)

(72) Inventors: Miyu HAGA, Susono-shi (JP); Tomotaka ISHIKAWA, Nagoya-shi (JP)

(21) Appl. No.: 17/652,830

(22) Filed: Feb. 28, 2022

(30) Foreign Application Priority Data
Mar. 2, 2021 (JP) 2021-032472

(51) Int. Cl. H01M 8/04089; H01M 8/04082; H01M 8/2475

(52) U.S. Cl. CPC H01M 8/04097; H01M 8/04201; H01M 8/2475; H01M 2250/20

(57) ABSTRACT

To provide a fuel cell system configured to, when fuel cell stacks are installed in a vehicle and an impurity is contained in fuel gas, minimize the number of fuel cell stacks to which the fuel gas containing the impurity is supplied. A fuel cell system wherein, after power generation by a first stack, a controller determines whether or not an impurity is contained in a fuel gas filled into a fuel tank; wherein, when the controller determines that an impurity is contained in the fuel gas filled into the fuel tank, the controller determines whether or not the impurity is a poisoning substance; and wherein, when the controller determines that the impurity is the poisoning substance, the controller prohibits the supply of the fuel gas to fuel cell stack(s) other than the first stack.

### TECHNICAL FIELD

The disclosure relates to a fuel cell system.

### BACKGROUND

A fuel cell (FC) is a power generation device that generates electrical energy by electrochemical reaction between fuel gas (e.g., hydrogen) and oxidant gas (e.g., oxygen) in a single unit fuel cell or a fuel cell stack (hereinafter, it may be referred to as “stack”) composed of stacked unit fuel cells (hereinafter may be referred to as “cell”). In many cases, the fuel gas and oxidant gas actually supplied to the fuel cell, are mixtures with gases that do not contribute to oxidation and reduction. Especially, the oxidant gas is often air containing oxygen.

Hereinafter fuel gas and oxidant gas may be collectively and simply referred to as “reaction gas” or “gas”. Also, a single unit fuel cell and a fuel cell stack composed of stacked unit cells may be referred to as “fuel cell”.

In general, the unit fuel cell includes a membrane-electrode assembly (MEA).

The membrane electrode assembly has a structure such that a catalyst layer and a gas diffusion layer (or GDL, hereinafter it may be simply referred to as “diffusion layer”) are sequentially formed on both surfaces of a solid polymer electrolyte membrane (hereinafter, it may be simply referred to as “electrolyte membrane”). Accordingly, the membrane electrode assembly may be referred to as “membrane electrode gas diffusion layer assembly” (MEGA).

As needed, the unit fuel cell includes two separators sandwiching both sides of the membrane electrode gas diffusion layer assembly. In general, the separators have a structure such that a groove is formed as a reaction gas flow path on a surface in contact with the gas diffusion layer. The separators have electronic conductivity and function as a collector of generated electricity.

In the fuel electrode (anode) of the fuel cell, hydrogen (H₂) as the fuel gas supplied from the gas flow path and the gas diffusion layer, is protonated by the catalytic action of the catalyst layer, and the protonated hydrogen goes to the oxidant electrode (cathode) through the electrolyte membrane. An electron is generated at the same time, and it passes through an external circuit, does work, and then goes to the cathode. Oxygen (O₂) as the oxidant gas supplied to the cathode reacts with protons and electrons in the catalytic layer of the cathode, thereby generating water. The generated water gives appropriate humidity to the electrolyte membrane, and excess water penetrates the gas diffusion layer and then is discharged to the outside of the system.

Various studies have been made on fuel cell systems configured to be installed and used in fuel cell electric vehicles (hereinafter may be referred to as “vehicle”).

For example, Patent Literature 1 discloses a CO poisoning judgment program and a CO poisoning self-diagnosis program, both of which are capable of notifying and informing a hydrogen station or a fuel cell electric vehicle of information on CO poisoning in a fuel cell electric vehicle.

Patent Literature 2 discloses a fuel cell system configured to shorten the activation time.

Patent Literature 3 discloses a fuel cell system configured to suppress such a situation, that fuel gas deficiency is caused by a deterioration in fuel gas purity, which is due to an impurity, and power generation becomes difficult.

Patent Literature 1: Japanese Patent Application Laid-Open (JP-A) No. 2019-102288

Patent Literature 2: JP-A No. 2007-165103

Patent Literature 3: JP-A No. 2009-110850

If an impurity is contained in hydrogen-containing fuel gas, a fuel cell causes not only insufficient power generation, but also irreversible performance degradation due to catalyst deterioration. Accordingly, it is important to control the purity of the fuel gas in the fuel cell.

In Patent Literature 1, on the basis that one fuel cell stack is installed in a fuel cell electric vehicle, CO poisoning is diagnosed by checking voltage reduction after a gas containing a poisoning gas is supplied to the fuel cell stack. In the case of installing a plurality of fuel cell stacks in one fuel cell electric vehicle, if the same CO poisoning diagnosis is performed by supplying the gas containing the poisoning gas to all the fuel cell stacks, the time required for maintenance and inspection of the vehicle increases as compared with the case of installing one fuel cell stack, and it is necessary to replace all the fuel cell stacks in some cases.

### SUMMARY

In light of the above circumstances, an object of the disclosed embodiments is to provide a fuel cell system configured to, when fuel cell stacks are installed in a vehicle and an impurity is contained in fuel gas, minimize the number of fuel cell stacks to which the fuel gas containing the impurity is supplied.

In a first embodiment, there is provided a fuel cell system,
wherein the fuel cell system comprises a stack group, a fuel tank for storing a fuel gas containing hydrogen, and a controller;
wherein the stack group includes two or more fuel cell stacks that are operable independently;
wherein the fuel gas is filled into the fuel tank, and when the fuel gas stored in the fuel tank is supplied to the stack group at a first activation of the fuel cell system after the filling, the controller supplies the fuel gas only to a first stack in the stack group and causes the first stack to generate power;
wherein, after the power generation by the first stack, the controller determines whether or not an impurity is contained in the fuel gas filled into the fuel tank;
wherein, when the controller determines that an impurity is contained in the fuel gas filled into the fuel tank, the controller determines whether or not the impurity is a poisoning substance; and
wherein, when the controller determines that the impurity is the poisoning substance, the controller prohibits the supply of the fuel gas to the fuel cell stack(s) other than the first stack.

When the controller determines that the poisoning substance is not contained in the fuel gas filled into the fuel tank, the controller may also supply the fuel gas to the fuel cell stack(s) other than the first stack.

In the fuel cell system of the disclosed embodiments, the stack group may include three or more of the fuel cell stacks that are operable independently; when the controller determines that the poisoning substance is contained in the fuel gas filled into the fuel tank, the controller may determine whether or not a power generation amount of the first stack is equal to or more than a predetermined threshold; when the controller determines that the power generation amount of the first stack is less than the predetermined threshold, the controller may also supply the fuel gas to a second stack included in the stack group and may prohibit the supply of the fuel gas to the fuel cell stacks other than the first stack and the second stack; and when the controller determines that the power generation amount of the first stack is equal to or more than the predetermined threshold, the controller may prohibit the supply of the fuel gas to the fuel cell stacks other than the first stack.

The controller may select the fuel cell stack that is most deteriorated from the stack group as the first stack.

In the fuel cell system of the disclosed embodiments, when the controller determines that the impurity is contained in the fuel gas filled into the fuel tank and determines that the impurity is nitrogen, the controller may determine whether or not a concentration of the hydrogen in the fuel gas is equal to or more than a predetermined threshold; when the controller determines that the concentration of the hydrogen in the fuel gas is less than the predetermined threshold, the controller may prohibit the supply of the fuel gas to the fuel cell stack(s) other than the first stack; and when the controller determines that the concentration of the hydrogen in the fuel gas is equal to or more than the predetermined threshold, the controller may also supply the fuel gas to the fuel cell stack(s) other than the first stack.

In the fuel cell system of the disclosed embodiments, the fuel cell system may be a fuel cell system for vehicles; the fuel cell system may further comprise a battery; and when the controller determines that the poisoning substance is contained in the fuel gas filled into the fuel tank, the controller may prohibit the supply of the fuel gas to the fuel cell stack(s) other than the first stack and may cause a vehicle to run only by power of the battery.

When the controller determines that the poisoning substance is contained in the fuel gas filled into the fuel tank, the controller may prohibit the supply of the fuel gas to the fuel cell stack(s) other than the first stack and may cause the vehicle to run only by the power of the battery and the power of the first stack.

According to the fuel cell system of the disclosed embodiments, when fuel cell stacks are installed in a vehicle and an impurity is contained in fuel gas, the number of fuel cell stacks to which the fuel gas containing the impurity is supplied, is minimized.

### BRIEF DESCRIPTION OF THE DRAWINGS

In the accompanying drawings,

FIG. 1 is a schematic configuration diagram of an example of the fuel cell system of the disclosed embodiments;

FIG. 2 is a flowchart illustrating an example of the control of the fuel cell system of the disclosed embodiments; and

FIG. 3 is a flowchart illustrating another example of the control of the fuel cell system of the disclosed embodiments.

### DETAILED DESCRIPTION

The fuel cell system of the disclosed embodiments is a fuel cell system,
wherein the fuel cell system comprises a stack group, a fuel tank for storing a fuel gas containing hydrogen, and a controller;
wherein the stack group includes two or more fuel cell stacks that are operable independently;
wherein the fuel gas is filled into the fuel tank, and when the fuel gas stored in the fuel tank is supplied to the stack group at a first activation of the fuel cell system after the filling, the controller supplies the fuel gas only to a first stack in the stack group and causes the first stack to generate power;
wherein, after the power generation by the first stack, the controller determines whether or not an impurity is contained in the fuel gas filled into the fuel tank;
wherein, when the controller determines that an impurity is contained in the fuel gas filled into the fuel tank, the controller determines whether or not the impurity is a poisoning substance; and
wherein, when the controller determines that the impurity is the poisoning substance, the controller prohibits the supply of the fuel gas to the fuel cell stack(s) other than the first stack.

According to the disclosed embodiments, in the fuel cell system including the fuel cell stacks, the fuel gas is filled into the fuel tank, and when the impurity is contained in the fuel gas at the first system activation after the filling, the fuel gas is supplied from the fuel tank to only one fuel cell stack, and it is possible to prevent the impurity from being supplied to other fuel cell stacks. Accordingly, it is possible to avoid performance degradation of all of the fuel cell stacks and, as a result, it is possible to reduce the burden on the user, such as the inspection time of the fuel cell system including the vehicle and the cost of replacing the fuel cell stacks.

In the disclosed embodiments, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.
In the disclosed embodiments, the impurity may be nitrogen, carbon monoxide, hydrogen sulfide or the like.
In the disclosed embodiments, the poisoning substance may be carbon monoxide, hydrogen sulfide or the like.

In general, the fuel cell system of the disclosed embodiments is installed and used in a vehicle including a motor as a driving source.
The fuel cell system of the disclosed embodiments may be installed and used in a vehicle that can be run by the power of a secondary cell.
The vehicle may be a fuel cell electric vehicle.
The vehicle may include the fuel cell system of the disclosed embodiments.
The motor is not particularly limited, and it may be a conventionally-known driving motor.

The fuel cell system of the disclosed embodiments includes the stack group.
The stack group includes two or more fuel cell stacks that are operable independently.
The number of the independently operable fuel cell stacks included in the stack group is not particularly limited, as long as it is 2 or more. It may be 10 or less, 5 or less, or 3 or less.
The condition in which two or more fuel cell stacks are independently operable, means the condition in which the fuel cell stacks can separately generate power.
The fuel cell stack is a stack composed of unit fuel cells.
The number of the stacked unit fuel cells is not particularly limited. For example, 2 to several hundred unit fuel cells may be stacked, or 2 to 200 unit fuel cells may be stacked.
The fuel cell stack may include an end plate at both stacking-direction ends of each unit fuel cell.

Each unit fuel cell includes at least a membrane electrode gas diffusion layer assembly.
The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes the cathode catalyst layer and the cathode-side gas diffusion layer.
The anode (fuel electrode) includes the anode catalyst layer and the anode-side gas diffusion layer.
The cathode catalyst layer and the anode catalyst layer are collectively referred to as “catalyst layer”. As the anode catalyst and the cathode catalyst, examples include, but are not limited to, platinum, (Pt) and ruthenium (Ru). As a catalyst-supporting material and a conductive material, examples include, but are not limited to, a carbonaceous material such as carbon.

The cathode-side gas diffusion layer and the anode-side gas diffusion layer are collectively referred to as “gas diffusion layer”.
The gas diffusion layer may be a gas-permeable electroconductive member or the like.
As the electroconductive member, examples include, but are not limited to, a porous carbon material such as carbon cloth and carbon paper, and a porous metal material such as metal mesh and foam metal.
The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

As needed, each unit fuel cell may include two separators sandwiching both sides of the membrane electrode gas diffusion layer assembly. One of the two separators is an anode-side separator, and the other is a cathode-side separator. In the disclosed embodiments, the anode-side separator and the cathode-side separator are collectively referred to as “separator”.
The separator may include supply and discharge holes for allowing the reaction gas and the refrigerant to flow in the stacking direction of the unit fuel cells. As the refrigerant, for example, a mixed solution of ethylene glycol and water may be used to prevent freezing at low temperature.
As the supply hole, examples include, but are not limited to, a fuel gas supply hole, an oxidant gas supply hole, and a refrigerant supply hole.
As the discharge hole, examples include, but are not limited to, a fuel gas discharge hole, an oxidant gas discharge hole, and a refrigerant discharge hole.
The separator may include one or more fuel gas supply holes, one or more oxidant gas supply holes, one or more refrigerant supply holes, one or more fuel gas discharge holes, one or more oxidant gas discharge holes, and one or more refrigerant discharge holes.
The separator may include a reactant gas flow path on a surface in contact with the gas diffusion layer. Also, the separator may include a refrigerant flow path for keeping the temperature of the fuel cell constant on the opposite surface to the surface in contact with the gas diffusion layer.
When the separator is the anode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The anode-side separator may include a fuel gas flow path for allowing the fuel gas to flow from the fuel gas supply hole to the fuel gas discharge hole, on the surface in contact with the anode-side gas diffusion layer. The anode-side separator may include a refrigerant flow path for allowing the refrigerant to flow from the refrigerant supply hole to the refrigerant discharge hole, on the opposite surface to the surface in contact with the anode-side gas diffusion layer.
When the separator is the cathode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The cathode-side separator may include an oxidant gas flow path for allowing the oxidant gas to flow from the oxidant gas supply hole to the oxidant gas discharge hole, on the surface in contact with the cathode-side gas diffusion layer. The cathode-side separator may include a refrigerant flow path for allowing the refrigerant to flow from the refrigerant supply hole to the refrigerant discharge hole, on the opposite surface to the surface in contact with the cathode-side gas diffusion layer.
The separator may be a gas-impermeable electroconductive member or the like. As the electroconductive member, examples include, but are not limited to, gas-impermeable dense carbon obtained by carbon densification, and a metal plate (such as an iron plate, an aluminum plate and a stainless-steel plate) obtained by press-molding. The separator may function as a collector.

The fuel cell stack may include a manifold such as an inlet manifold communicating between the supply holes and an outlet manifold communicating between the discharge holes.
As the inlet manifold, examples include, but are not limited to, an anode inlet m anifold, a cathode inlet manifold, and a refrigerant inlet manifold.
As the outlet manifold, examples include, but are not limited to, an anode outlet manifold, a cathode outlet manifold, and a refrigerant outlet manifold.

The fuel cell system includes the fuel tank as the fuel gas system of the fuel cell. The fuel cell system may include, as the fuel gas system of the fuel cell, a fuel gas supply flow path, a fuel off-gas discharge flow path, an ejector, and a circulation flow path. The fuel gas system may be independently disposed in each fuel cell stack. The fuel gas system other than the fuel tank and the fuel gas supply flow path may be independently disposed in each fuel cell stack.

The fuel tank stores the fuel gas containing hydrogen.
As the fuel tank, examples include, but are not limited to, a liquid hydrogen tank and a compressed hydrogen tank.
The fuel tank may include a main shutoff valve.
The main shutoff valve is electrically connected to the controller, and ON/OFF of the fuel gas supply to the fuel cell may be controlled by controlling the opening and closing of the main shutoff valve according to a control signal from the controller.

The fuel gas supply flow path connects the fuel tank and the fuel gas inlet of each fuel cell stack of the stack group. The fuel gas supply flow path may be independently disposed in each fuel cell stack, or one fuel gas supply flow path may be branched and connected to the fuel cell stacks. The fuel gas supply flow path allows the fuel gas to be supplied to the anode of the fuel cell. The fuel gas inlet may be the fuel gas supply hole, the anode inlet manifold or the like.

The fuel gas supply flow path may include a fuel gas supply valve that allows the fuel gas to be supplied to each fuel cell stack. The fuel gas supply valve may be independently disposed in each fuel cell stack.
The fuel gas supply valve is electrically connected to the controller, and ON/OFF of the fuel gas supply to each fuel cell stack may be controlled by controlling the opening and closing of the fuel gas supply valve according to a control signal from the controller. By opening and closing the fuel gas supply valve, each fuel cell stack can be independently operated.

In the fuel gas supply flow path, a fuel gas pressure control valve may be disposed downstream from the fuel gas supply valve. The fuel gas pressure control valve may be independently disposed in each fuel cell stack.
The fuel gas pressure control valve is electrically connected to the controller, and the pressure of the fuel gas supplied from the fuel tank may be controlled by controlling the opening degree of the fuel gas pressure control valve according to a control signal from the controller.
In the fuel gas supply flow path, an injector may be disposed downstream from the fuel gas pressure control valve. The injector may be independently disposed in each fuel cell stack.
The injector supplies the fuel gas to the ejector. As the injector, a conventionally-known injector may be used.

In the fuel gas supply flow path, the ejector may be disposed downstream from the injector. The ejector may be independently disposed in each fuel cell stack.
For example, the ejector may be disposed at a junction with the circulation flow path on the fuel gas supply flow path. The ejector supplies a mixed gas containing the fuel gas and circulation gas to the anode of the fuel cell. As the ejector, a conventionally-known ejector may be used.

The fuel off-gas discharge flow path discharges, to the outside of the fuel cell system, the fuel off-gas discharged from the fuel gas outlet of the fuel cell. The fuel off-gas discharge flow path may be independently disposed in each fuel cell stack. The fuel gas outlet may be the fuel gas discharge hole, the anode outlet manifold, or the like.

An anode gas-liquid separator may be disposed in the fuel off-gas discharge flow path. The anode gas-liquid separator may be independently disposed in each fuel cell stack.
The anode gas-liquid separator may be disposed at the branch point of the fuel off-gas discharge flow path and the circulation flow path.
The anode gas-liquid separator is disposed upstream from the vent and discharge valve of the fuel off-gas discharge flow path.
The anode gas-liquid separator separates the water and fuel gas contained in the fuel off-gas, which is the fuel gas discharged from the fuel gas outlet. Accordingly, the fuel gas may be returned to the circulation flow path as the circulation gas, or unnecessary gas, water and the like may be discharged to the outside by opening the vent and discharge valve of the fuel off-gas discharge flow path. In addition, the anode gas-liquid separator can suppress the flow of excess water into the circulation flow path. Accordingly, the occurrence of freezing of the circulation pump or the like due to the water, can be suppressed.

The vent and discharge valve (the fuel off-gas discharge valve) may be disposed in the fuel off-gas discharge flow path. The vent and discharge valve may be independently disposed in each fuel cell stack. The vent and discharge valve is disposed downstream from the gas-liquid separator in the fuel off-gas discharge flow path.
The vent and discharge valve allows the fuel off-gas, water and the like to be discharged to the outside (of the system). The outside may be the outside of the fuel cell system, or it may be the outside of the vehicle.
The vent and discharge valve may be electrically connected to the controller, and the flow rate of the fuel off-gas discharged to the outside may be controlled by controlling the opening and closing of the vent and discharge valve by the controller. By controlling the opening degree of the vent and discharge valve, the pressure of the fuel gas supplied to the anode of the fuel cell (anode pressure) may be controlled.
The fuel off-gas may contain the fuel gas that has passed through the anode without reacting, and the water generated at the cathode and delivered to the anode. In some cases, the fuel off-gas contains corroded substances generated in the catalyst layer, the electrolyte membrane or the like, and the oxidant gas or the like allowed to be supplied to the anode during a purge.

The circulation flow path connects the anode gas-liquid separator and the ejector. The circulation flow path may be independently disposed in each fuel cell stack.
The circulation flow path allows the fuel off-gas, which is the fuel gas discharged from the fuel gas outlet of the fuel cell, to be recovered and supplied to the fuel cell as the circulation gas.
The circulation flow path may branch from the fuel off-gas discharge flow path through the anode gas-liquid separator and connect to the ejector disposed in the fuel gas supply flow path, thereby joining the fuel gas supply flow path.

The circulation pump may be disposed in the circulation flow path. The circulation pump may be independently disposed in each fuel cell stack.
The circulation pump circulates the fuel off-gas as the circulation gas. The circulation pump may be electrically connected to the controller, and the flow rate of the circulation gas may be controlled by controlling the turning on/off, rotational frequency, etc., of the circulation pump by the controller.

The fuel cell system may include a pressure sensor. The pressure sensor may be independently disposed in each fuel cell stack.
The pressure sensor detects the pressure of the fuel cell. The pressure sensor is electrically connected to the controller. The position of the pressure sensor is not particularly limited, as long as it can detect the pressure of the fuel cell.
As the pressure sensor, a conventionally-known pressure meter or the like may be used.
From the pressure detected by the pressure sensor, the controller may estimate the presence or absence of the impurity, the concentration of the impurity, the concentration of the hydrogen, the power generation amount of the fuel cell, and the like.
The controller may preliminarily store a data group indicating the relationship between the pressure and the type and concentration of the impurity in the fuel gas, and then it may estimate the type and concentration of the impurity by comparing the pressure detected by the pressure sensor with the data group.

The fuel cell system may include a gas sensor. The gas sensor may be independently disposed in each fuel cell stack.
The gas sensor is disposed at any position of the fuel gas supply flow path. The gas sensor may be disposed upstream from the fuel gas supply valve of the fuel gas supply flow path.
The gas sensor detects the impurity in the fuel gas. The gas sensor is electrically connected to the controller. The controller may detect the type, concentration, etc., of the impurity detected by the gas sensor.
As the gas sensor, a conventionally-known gas detector or the like may be used.

The fuel cell system may include a hydrogen concentration sensor. The hydrogen concentration sensor may be independently disposed in each fuel cell stack.
The hydrogen concentration sensor is disposed at any position of the fuel gas supply flow path. The hydrogen concentration sensor may be disposed upstream from the fuel gas supply valve of the fuel gas supply flow path.
The hydrogen concentration sensor detects the hydrogen concentration of the fuel gas. The hydrogen concentration sensor is electrically connected to the controller. The controller may determine whether or not the hydrogen concentration detected by the hydrogen concentration sensor is equal to or more than the predetermined threshold.
As the hydrogen concentration sensor, a conventionally-known concentration meter or the like may be used.

The fuel cell system may include a current sensor. The current sensor may be independently disposed in each fuel cell stack.
The current sensor detects the current value of the fuel cell. The current sensor is electrically connected to the controller. The position of the current sensor is not particularly limited, as long as it can detect the current value of the fuel cell.
As the current sensor, a conventionally-known ammeter or the like may be used.
The controller may calculate the power generation amount of the fuel cell from the current value detected by the current sensor.

As the oxidant gas system of the fuel cell, the fuel cell system may include an oxidant gas supplier, an oxidant gas supply flow path, and an oxidant off-gas discharge flow path. The oxidant gas system may be independently disposed in each fuel cell stack.
The oxidant gas supplier supplies the oxidant gas to the cathode of the fuel cell.
As the oxidant gas supplier, for example, an air compressor may be used.
The oxidant gas supplier is electrically connected to the controller. The oxidant gas supplier is driven according to a control signal from the controller. At least one selected from the group consisting of the flow rate and pressure of the oxidant gas supplied from the oxidant gas supplier to the cathode, may be controlled by the controller.
The oxidant gas supply flow path connects the oxidant gas supplier and the oxidant gas inlet of the fuel cell. The oxidant gas supply flow path allows the oxidant gas to be supplied from the oxidant gas supplier to the cathode of the fuel cell. The oxidant gas inlet may be the oxidant gas supply hole, the cathode inlet manifold, or the like.
The oxidant off-gas discharge flow path is connected to the oxidant gas outlet of the fuel cell. The oxidant off-gas discharge flow path allows the oxidant off-gas, which is the oxidant gas discharged from the cathode of the fuel cell, to be discharged to the outside. The oxidant gas outlet may be the oxidant gas discharge hole, the cathode outlet manifold, or the like.
The oxidant off-gas discharge flow path may be provided with an oxidant gas pressure control valve.
The oxidant gas pressure control valve is electrically connected to the controller. By opening the oxidant gas pressure control valve by the controller, the oxidant off-gas, which is the reacted oxidant gas, is discharged to the outside from the oxidant off-gas discharge flow path. The pressure of the oxidant gas supplied to the cathode (cathode pressure) may be controlled by controlling the opening degree of the oxidant gas pressure control valve.

The fuel cell system may include a refrigerant supplier and a refrigerant circulation flow path as the cooling system of the fuel cell. The cooling system may be independently disposed in each fuel cell stack.
The refrigerant circulation flow path communicates between the refrigerant supply and discharge holes provided in the fuel cell, and it allows the refrigerant supplied from the refrigerant supplier to be circulated inside and outside the fuel cell.
The refrigerant supplier is electrically connected to the controller. The refrigerant supplier is driven according to a control signal from the controller. The flow rate of the refrigerant supplied from the refrigerant supplier to the fuel cell, is controlled by the controller. The temperature of the fuel cell may be controlled thereby.
As the refrigerant supplier, examples include, but are not limited to, a cooling water pump.
The refrigerant circulation flow path may be provided with a radiator for heat dissipation from the cooling water.
The refrigerant circulation flow path may be provided with a reserve tank for storing the refrigerant.

The fuel cell system may include a secondary cell.
The secondary cell (battery) may be any chargeable and dischargeable cell. For example, the secondary cell may be a conventionally known secondary cell such as a nickel-hydrogen secondary cell and a lithium ion secondary cell. The secondary cell may include a power storage element such as an electric double layer capacitor. The secondary cell may have a structure such that a plurality of secondary cells are connected in series. The secondary cell supplies power to the motor, the oxidant gas supplier and the like. The secondary cell may be rechargeable by a power source outside the vehicle, such as a household power supply. The secondary cell may be charged by the output power of the fuel cell. The charge and discharge of the secondary cell may be controlled by the controller.

The controller physically includes a processing unit such as a central processing unit (CPU), a memory device such as a read-only memory (ROM) and a random access memory (RAM), and an input-output interface. The ROM is used to store a control program, control data and so on to be processed by the CPU, and the RAM is mainly used as various workspaces for control processing. The controller may be a control device such as an electronic control unit (ECU).
The controller may be electrically connected to an ignition switch which may be installed in the vehicle. The controller may be operable by an external power supply even if the ignition switch is turned off.

The fuel gas is filled into the fuel tank, and when the fuel gas stored in the fuel tank is supplied to the stack group at the first activation of the fuel cell system after the filling, the controller supplies the fuel gas only to the first stack in the stack group, permits power generation by only the first stack, and causes the first stack to generate power.
After the power generation by the first stack, the controller determines whether or not the impurity is contained in the fuel gas filled into the fuel tank.
When the controller determines that an impurity is contained in the fuel gas filled into the fuel tank, the controller determines whether or not the impurity is the poisoning substance.
When the controller determines that the impurity is the poisoning substance, the controller prohibits the supply of the fuel gas to the fuel cell stack(s) other than the first stack, and prohibits power generation by the fuel cell stack(s) other than the first stack.
When the controller determines that the poisoning substance is not contained in the fuel gas filled into the fuel tank, the controller may also supply the fuel gas to the fuel cell stack(s) other than the first stack and may also permit power generation by the fuel cell stack(s) other than the first stack.
The determination as to whether or not the hydrogen gas contains the impurity, may be made in accordance with the power generation characteristics of the fuel cell stack, as described in Japanese Patent Laid-Open No. 2019-102288 for example, or it may be made in accordance with the detection value of the gas sensor provided for detection of the impurity.
The determination as to whether or not the fuel gas contains the poisoning substance as the impurity, may be made as follows: it may be determined that the fuel gas contains the poisoning substance as the impurity, when a predetermined poisoning substance concentration reference value is exceeded, and a predetermined amount (trace amount) of the poisoning substance may be contained in the fuel gas. The poisoning substance concentration reference value may be appropriately set in accordance with allowable fuel cell performance.

When the stack group includes three or more of the fuel cell stacks that are operable independently and when the controller determines that the poisoning substance is contained in the fuel gas filled into the fuel tank, the controller may determine whether or not the power generation amount of the first stack is equal to or more than the predetermined threshold.
When the controller determines that the power generation amount of the first stack is less than the predetermined threshold, the controller may also supply the fuel gas to the second stack included in the stack group, may also permit power generation by the second stack, may prohibit the supply of the fuel gas to the fuel cell stacks other than the first stack and the second stack, and may prohibit power generation by the fuel cell stacks other than the first stack and the second stack.
When the controller determines that the power generation amount of the first stack is equal to or more than the predetermined threshold, the controller may prohibit the supply of the fuel gas to the fuel cell stacks other than the first stack and may prohibit power generation by the fuel cell stacks other than the first stack.
When the fuel cell system includes three or more fuel cell stacks, at the system activation just after the fuel gas filling, the fuel gas may be supplied to one or more (but not all) of the fuel cell stacks, and the one or more of the fuel cell stacks may be caused to generate power.
The number of the fuel cell stacks that are damaged by the poisoning substance, can be reduced when the number of the stacks that supply the fuel gas is small. Meanwhile, when the power generation amount of the first stack is less than the predetermined threshold and the power of only one fuel cell stack is insufficient to drive to a dealer, some (but not all) of the stacks may be caused to generate power.

The controller may select the fuel cell stack that is most deteriorated from the stack group as the first stack. For example, the voltage values of the fuel cell stacks when they are caused to generate power at a predetermined frequency and under the same conditions (current amount, gas supply amount, temperature) are obtained, and the fuel cell stack having the lowest voltage value may be determined as the most deteriorated fuel cell stack.
In the case of the system in which the fuel cell stack used for power generation is switched according to the conditions, the fuel cell stack having the longest operating time may be determined as the most deteriorated stack.

When the controller determines that the impurity is contained in the fuel gas filled into the fuel tank and determines that the impurity is nitrogen, the controller may determine whether or not the concentration of the hydrogen in the fuel gas is equal to or more than the predetermined threshold.
When the controller determines that the concentration of the hydrogen in the fuel gas is less than the predetermined threshold, the controller may prohibit the supply of the fuel gas to the fuel cell stack(s) other than the first stack and may prohibit power generation by the fuel cell stack(s) other than the first stack.
When the controller determines that the concentration of the hydrogen in the fuel gas is equal to or more than the predetermined threshold, the controller may also supply the fuel gas to the fuel cell stack(s) other than the first stack and may also permit power generation by the fuel cell stack(s) other than the first stack.
At the time of performing the impurity determination by power generation of a part of the stacks, when the impurity contained in the fuel gas filled into the fuel tanks is not the poisoning substance (such as CO and H₂S) and is nitrogen (N₂), the hydrogen concentration and the anode pressure are controlled to be increased. Then, for example, when the hydrogen concentration becomes equal to or more than the threshold at which the stacks are not deteriorated and partial hydrogen deficiency is not generated, power generation permission may be given to all of the stacks. When the fuel gas contains not only nitrogen but also the poisoning substance as the impurity, power generation permission is given to only a part of the stacks and is not given to the other stacks.
On the other hand, when the hydrogen concentration is less than the threshold at which the stacks are not deteriorated, power generation permission is given to only a part of the stacks and is not given to the other stacks.
The determination as to whether or not the fuel gas contains nitrogen as the impurity, may be made in accordance with, for example, the power generation characteristics of the fuel cell stacks, or it may be made in accordance with the detection value of the gas sensor provided for detection of the impurity.
The determination as to whether or not the fuel gas contains nitrogen as the impurity, may be made as follows: it may be determined that the fuel gas contains nitrogen as the impurity, when a predetermined nitrogen concentration reference value is exceeded, and a predetermined amount of nitrogen may be contained. The nitrogen concentration reference value may be appropriately set in accordance with allowable fuel cell performance.
The hydrogen concentration may be estimated as follows: the pressure of the fuel gas supplied to the fuel cell is measured by the pressure sensor, and the hydrogen concentration is estimated from the measured pressure value. For example, a data group indicating the relationship between the hydrogen concentration and the pressure value of the fuel gas may be preliminarily prepared, and the hydrogen concentration may be estimated by comparing the measured pressure value with the data group.
Also, the hydrogen concentration may be measured by the hydrogen concentration sensor disposed in the system.

### (Limited Running 1)

When the fuel cell system is a fuel cell system for vehicles, when the fuel cell system further includes a battery, and when the controller determines that the poisoning substance is contained in the fuel gas filled into the fuel tank, the controller may prohibit the supply of the fuel gas to the fuel cell stack(s) other than the first stack and may cause a vehicle to run only by the power of the battery.
Accordingly, performance degradation of the first stack is minimized. In addition, performance deterioration of the fuel cell stacks other than the first stack is minimized.

### (Limited Running 2)

When the fuel cell system is a fuel cell system for vehicles, when the fuel cell system further includes a battery, and when the controller determines that the poisoning substance is contained in the fuel gas filled into the fuel tank, the controller may prohibit the supply of the fuel gas to the fuel cell stack(s) other than the first stack, may prohibit power generation by the fuel cell stack(s) other than the first stack, and may cause the vehicle to run only by the power of the battery and the power of the first stack. As needed, the output of the fuel cell stacks may be limited, or the operator may be prompted to visit a hydrogen station or dealer for checkup.
Accordingly, the vehicle is allowed to run a longer distance than in the case of the limited running 1. In addition, performance degradation of the stacks other than the first stack is prevented.

### (Limited Running 3)

When the fuel cell system is a fuel cell system for vehicles, when the fuel cell system further includes a battery, and when the controller determines that the poisoning substance is contained in the fuel gas filled into the fuel tank, the controller prohibits the supply of the fuel gas to the fuel cell stack(s) other than the first stack, prohibits power generation by the fuel cell stack(s) other than the first stack, and causes the vehicle to run only by the power of the battery and the power of the first stack. Then, when the power of the first stack becomes insufficient, the controller may supply the fuel to the second stack, may permit power generation by the second stack, and may cause the second stack to generate power.
Accordingly, the vehicle is allowed to run a longer distance than in the case of the limited running 2. In addition, performance degradation of the second stack is suppressed, and performance degradation of the stacks other than the first and second stacks, is prevented.

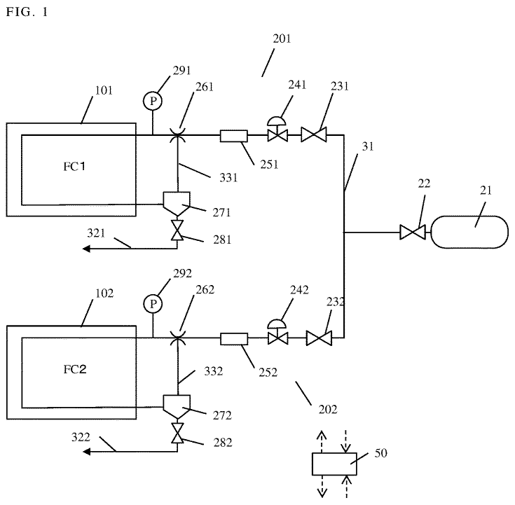

FIG. 1 is a schematic configuration diagram of an example of the fuel cell system of the disclosed embodiments.
The fuel cell system shown in FIG. 1 includes two fuel cell stacks 101 and 102, a fuel tank 21 including a main shutoff valve 22, a fuel gas supply flow path 31, and fuel gas systems 201 and 202 for independently supplying, circulating and discharging the fuel to the fuel cell stacks. The fuel gas systems 201 and 202 include common components, and they are independently controlled by an electronic control unit (ECU) 50. The fuel gas system 201 includes a fuel gas supply valve 231 to switch between supplying the fuel gas stored in the fuel tank 21 to the fuel cell stack 101 and shutting off the fuel gas. The fuel gas system 202 includes a fuel gas supply valve 232 to switch between supplying the fuel gas stored in the fuel tank 21 to the fuel cell stack 102 and shutting off the fuel gas. If the stack to be used for power generation at the first system activation after filling the fuel gas into the fuel tank 21, is predetermined (e.g., to the fuel cell stack 101), the fuel gas supply valve 231 is not needed. The fuel gas system 201 includes a fuel gas pressure control valve 241, an injector 251, an ejector 261, an anode gas-liquid separator 271, a discharge valve 281, a pressure sensor 291, a fuel off-gas discharge flow path 321, and a circulation flow path 331. The fuel gas system 202 includes a fuel gas pressure control valve 242, an injector 252, an ejector 262, an anode gas-liquid separator 272, a discharge valve 282, a pressure sensor 292, a fuel off-gas discharge flow path 322, and a circulation flow path 332. As needed, the fuel cell system may include the gas sensor, the hydrogen concentration sensor, the current sensor and the like. In FIG. 1, only the fuel gas system is illustrated, and other systems such as the oxidant gas system and the cooling system are not illustrated.

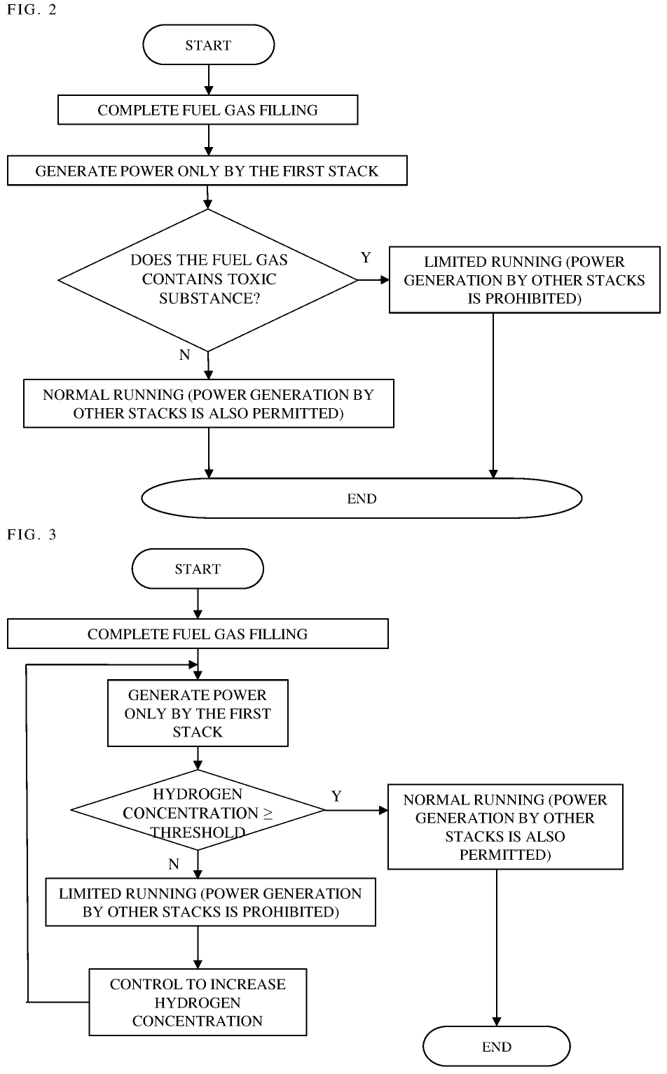

FIG. 2 is a flowchart illustrating an example of the control of the fuel cell system of the disclosed embodiments.
At the first system activation after the fuel gas is filled into the fuel tank, the controller causes only the first stack to generate power.
   Then, as the impurity determination, the controller determines whether the fuel gas contains the poisoning substance as the impurity.
When it is determined that the fuel gas does not contain the poisoning substance as the impurity, the controller performs normal running in which power generation permission is also given to the other stacks, and then it ends the control.
On the other hand, when the controller determines that the fuel gas contains the poisoning substance as the impurity, the controller performs limited running to prohibit power generation of the other stacks, and then it ends the control.

FIG. 3 is a flowchart illustrating another example of the control of the fuel cell system of the disclosed embodiments. FIG. 3 is an example of the control when the fuel gas contains only nitrogen as the impurity in the impurity determination. In the impurity determination, when the fuel gas contains not only nitrogen but also the poisoning substance as the impurity, the control may be performed along the flowchart of FIG. 2.
At the first system activation after the fuel gas is filled into the fuel tank, the controller causes only the first stack to generate power.
Then, as the impurity determination, the controller determines whether or not the hydrogen concentration is equal to or more than the threshold when the controller determines that the fuel gas contains only nitrogen as the impurity.
When the controller determines that the hydrogen concentration is equal to or more than the threshold, the controller performs normal running in which power generation permission is also given to the other stacks, and then it ends the control.
On the other hand, when the controller determines that the hydrogen concentration is less than the threshold, the controller performs limited running to prohibit power generation of the other stacks, and then it ends the control.

### REFERENCE SIGNS LIST

101, 102: Fuel cell stack
201, 202: Fuel gas system
21: Fuel tank
22: Shutoff valve
231, 232: Fuel gas supply valve
241, 242: Fuel gas pressure control valve

### 251, 252: Injector

### 261, 262: Ejector

271, 272: Anode gas-liquid separator
281, 282: Vent and discharge valve
291, 292: Pressure sensor
31: Fuel gas supply flow path
321, 322: Fuel off-gas discharge flow path
331, 332: Circulation flow path

### 50: Controller (ECU)

1. A fuel cell system,
wherein the fuel cell system comprises a stack group, a fuel tank for storing a fuel gas containing hydrogen, and a controller;
wherein the stack group includes two or more fuel cell stacks that are operable independently;
wherein the fuel gas is filled into the fuel tank, and when the fuel gas stored in the fuel tank is supplied to the stack group at a first activation of the fuel cell system after the filling, the controller supplies the fuel gas only to a first stack in the stack group and causes the first stack to generate power;
wherein, after the power generation by the first stack, the controller determines whether or not an impurity is contained in the fuel gas filled into the fuel tank;
wherein, when the controller determines that an impurity is contained in the fuel gas filled into the fuel tank, the controller determines whether or not the impurity is a poisoning substance; and
wherein, when the controller determines that the impurity is the poisoning substance, the controller prohibits the supply of the fuel gas to the fuel cell stack(s) other than the first stack.

2. The fuel cell system according to claim 1, wherein, when the controller determines that the poisoning substance is not contained in the fuel gas filled into the fuel tank, the controller also supplies the fuel gas to the fuel cell stack(s) other than the first stack.

3. The fuel cell system according to claim 1,
wherein the stack group includes three or more of the fuel cell stacks that are operable independently;
wherein, when the controller determines that the poisoning substance is contained in the fuel gas filled into the fuel tank, the controller determines whether or not a power generation amount of the first stack is equal to or more than a predetermined threshold;
wherein, when the controller determines that the power generation amount of the first stack is less than the predetermined threshold, the controller also supplies the fuel gas to a second stack included in the stack group and prohibits the supply of the fuel gas to the fuel cell stacks other than the first stack and the second stack; and
wherein, when the controller determines that the power generation amount of the first stack is equal to or more than the predetermined threshold, the controller prohibits the supply of the fuel gas to the fuel cell stacks other than the first stack.

4. The fuel cell system according to claim 1, wherein the controller selects the fuel cell stack that is most deteriorated from the stack group as the first stack.

5. The fuel cell system according to claim 1, wherein, when the controller determines that the impurity is contained in the fuel gas filled into the fuel tank and determines that the impurity is nitrogen, the controller determines whether or not a concentration of the hydrogen in the fuel gas is equal to or more than a predetermined threshold;
wherein, when the controller determines that the concentration of the hydrogen in the fuel gas is less than the predetermined threshold, the controller prohibits the supply of the fuel gas to the fuel cell stack(s) other than the first stack; and
wherein, when the controller determines that the concentration of the hydrogen in the fuel gas is equal to or more than the predetermined threshold, the controller also supplies the fuel gas to the fuel cell stack(s) other than the first stack.

6. The fuel cell system according to claim 1,
wherein the fuel cell system is a fuel cell system for vehicles;
wherein the fuel cell system further comprises a battery; and
wherein, when the controller determines that the poisoning substance is contained in the fuel gas filled into the fuel tank, the controller prohibits the supply of the fuel gas to the fuel cell stack(s) other than the first stack and causes a vehicle to run only by power of the battery.

7. The fuel cell system according to claim 6, wherein, when the controller determines that the poisoning substance is contained in the fuel gas filled into the fuel tank, the controller prohibits the supply of the fuel gas to the fuel cell stack(s) other than the first stack and causes the vehicle to run only by the power of the battery and the power of the first stack.
